(19) United States
(12) Patent Application Publication
(10) Pub. No.: US 2012/0003523 A1
(43) Pub. Date: Jan. 5, 2012

(54) BATTERY THERMAL MANAGEMENT WITH PHASE TRANSITION

(75) Inventors: Rolf Schaller, Stuttgart (DE); Sehoon Kwak, Auburn Hills, MI (US)

(73) Assignee: CHRYSLER GROUP LLC, Auburn Hills, MI (US)

(21) Appl. No.: 13/232,234

(22) Filed: Sep. 14, 2011

Related U.S. Application Data
(63) Continuation of application No. 10/603,476, filed on Jun. 25, 2003, now abandoned.

(51) Int. Cl. H01M 10/02; H01M 10/42; H01M 10/50; H01M 10/00; H01M 2/02

(52) U.S. Cl. 429/120; 429/122; 429/156; 429/163; 429/50

(57) ABSTRACT

An apparatus and method provide battery thermal management through the use of a battery cell having an internal cavity and a phase change material (PCM) disposed in the internal cavity of the battery cell. By locating the PCM inside of the battery cell, the entire outer surface of the cell is accessible for direct heat transfer to a heat exchange apparatus.

### CROSS REFERENCE TO RELATED APPLICATIONS

This application is a continuation of U.S. Ser. No. 10/603,476, filed Jun. 25, 2003.

### TECHNICAL FIELD OF THE INVENTION

This invention relates to batteries and their operation, and more particularly to thermal management in a battery through the use of a phase change material (PCM).

### BACKGROUND OF THE INVENTION

The term “battery” as used herein refers to any form of an electrochemical power generation device in which electrical power is stored, and/or generated from the release of chemical energy by the reaction of one or more chemical reactants stored in a confined space and reacted with one another or with an external reactant in an electrochemical reaction. Such batteries may include various types of commonly known expendable and rechargeable wet and dry cell batteries, and fuel cells in which a fuel cell reaction is used to generate electric power from a reactant (fuel) that is consumed and must be replenished from time to time for continued operation.

During operation, discharge, and recharge, the electrochemical reaction inside such batteries generates considerable heat, which can significantly affect the performance and life of the battery. Electrochemical reactions also typically proceed most efficiently within a range of optimal operating temperatures. It is, therefore generally necessary and desirable to ensure that such batteries operate within a fairly narrow prescribed range of temperatures.

Where it is desirable to make the battery small in physical size and weight, for use in electric vehicles or aircraft, for example, it is often necessary to provide some type of heat exchanging apparatus for removing or adding heat to the battery, in order to maintain the operating temperature within desired limits. Such heat exchanging devices and systems often provide cooling and/or heating of an external surface of the battery. Where the battery includes only a single battery cell, this cooling or heating may be applied directly to an entire outer surface of the battery cell. Where the battery includes multiple battery cells enclosed in a battery case, the cooling or heating may be applied to the battery case.

In some applications it is highly desirable to minimize the size, weight, cost and complexity of the heat exchange apparatus. One prior approach to providing a small, simple, and efficient structure and method for maintaining the temperature of the battery within a desired range, utilizes a wax-like phase change material (PCM) to store heat during operation of the battery.

Phase change materials utilize the principle of latent heat transfer for accomplishing this function. At an initial temperature, the PCM exists in an essentially solid, “frozen” state. As heat is added to the PCM, the temperature of the PCM rises until a transition temperature of the PCM is reached, and the PCM begins to melt and change to a liquid state. As further heat is added, the temperature of the PCM does not rise further, i.e. remains constant at the transition temperature, until all of the PCM has melted. Once all of the PCM has changed state, by melting, the temperature of the melted PCM will once again rise as further heat is added. Removal of heat from the melted PCM causes the opposite effect. The temperature falls until the PCM transition temperature is reached, and the PCM begins to re-solidify. Further heat removal will not reduce the temperature of the PCM until all of the melted PCM has transitioned back to the solid state. The amount of heat needed to accomplish a complete transition of a volume of PCM is known as the latent heat of the PCM material.

The transition temperature and latent heat are unique characteristics of the particular PCM utilized. PCMs are available in various formulations providing a wide variety of combinations of transition temperature and latent heat values. By judicious selection of the chemical composition and volume of particular PCM to be used, a PCM can be provided that will maintain a transition temperature within a desired operating temperature range of a battery for a desired operating cycle of the battery. The use of PCM materials in this manner can be particularly effective for batteries that experience periodic high rates of heat transfer during rapid discharges or re-charges, separated by longer periods of operation causing lower heat generation levels during which steady state heat transfer from the battery can maintain the PCM at the transition temperature.

One prior approach to utilizing the principle of latent heat transfer for maintaining the temperature of a battery within desired limits, surrounds all, or a part of an external surface of a battery or a battery cell with a layer of PCM. This may be accomplished by wrapping a pouch or blanket containing PCM around the battery, or a case of the battery.

Utilizing such an approach, however, can be undesirable, however, because the PCM acts as a thermally insulator making it difficult to provide a good heat transfer path between the battery cells, where the heat is being generated, and a heat exchange apparatus for removing heat from the battery cells.

In another approach, as exemplified by U.S. Pat. No. 6,468,689 B1, to Hallaj et al, a battery is constructed of a plurality of cylindrical shaped battery cells enclosed in a common rectilinear-shaped battery case, and the space inside the case around battery cells is filled with a PCM. Heat generated by the battery cells causes the temperature of the PCM to rise until the PCM transition temperature is reached. Additional heat generated by the PCM is absorbed as the latent heat of the PCM with PCM remaining constant at the transition temperature until all of the PCM has changed state, before the PCM temperature begins to rise again. The melting PCM maintains the battery cells essentially at the transition temperature, until all of the PCM has changed state. As heat is removed from the battery case, the PCM is cooled to the transition temperature, and then remains constant at the transition temperature until all of the PCM has transitioned back to a solid state. This approach suffers from some of the same drawbacks described above with regard to surrounding the battery with pouches or blankets containing PCM, in that the PCM surrounding the battery cells serves as an insulator, making it difficult to remove heat from the battery cells through the battery case, and potentially resulting in overheating of the battery cells and longer than desirable thermal cycle times.

What is needed, therefore, is an improved apparatus and method for accomplishing battery thermal management through use of a phase change material.

### SUMMARY OF THE INVENTION

Our invention provides such an improved apparatus and method for accomplishing battery thermal management through use of a battery cell having an internal cavity and a phase change material (PCM) disposed in the internal cavity of the battery cell. By locating the PCM inside of the battery cell, rather than outside of the battery cell as in prior batteries, the advantages provided through the use of the PCM are maintained and optimized, and overall heat transfer capability of the battery cell is significantly enhanced by making the entire outer surface of the cell accessible for direct heat transfer to a heat exchange apparatus.

The foregoing and other features and advantages of our invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1-3 are perspective representations of several embodiments of a battery cell having an internal cavity with phase change material (PCM) therein, according to our invention;

FIG. 4 is schematic representation of a battery apparatus, according to our invention; and

FIGS. 5-8 are graphs representing the performance of a computer model of a battery cell according to our invention.

### DETAILED DESCRIPTION

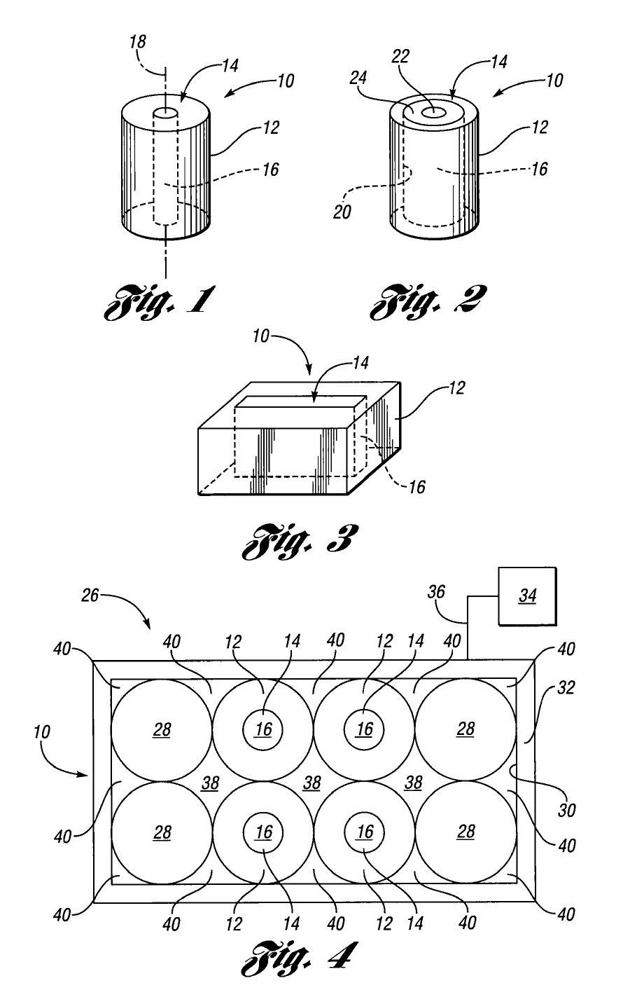

FIGS. 1-3 show several embodiments of battery 10 comprising a battery cell 12 having an internal cavity 14 and a phase change material (PCM) 16 disposed in the internal cavity 14 of the battery cell 12.

The batteries 10 illustrated in FIGS. 1-3 all have cells 12 that are generally tubular shaped. The battery 10 of FIG. 1 is cylindrical in shape and defines a longitudinal axis 18 thereof, and the internal cavity 14 extends along the longitudinal axis 18. The battery 10 of FIG. 3 is prismatic in shape.

The battery of FIG. 2 includes a first battery cell 12 having an internal cavity 14 defining a wall 20 of the internal cavity 14. A second battery cell 22 is disposed within the internal cavity 14 of the first battery cell 12, and is spaced from the wall 20 to form a gap 24 between the first and second battery cells 12, 22. The phase change material 16 is disposed in the gap 24 between the first and second battery cells 12, 22.

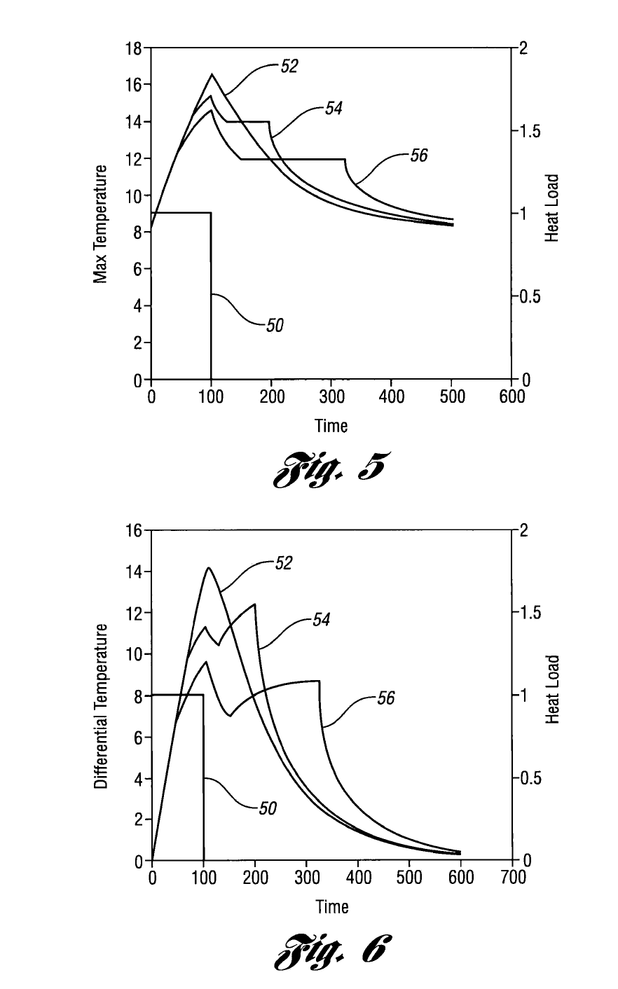

FIG. 4 shows a battery apparatus 26 including a battery 10 having eight Icylindrical shaped battery cells 12, 28 disposed in a rectangular array a battery case 30 contacting the outer surfaces of the cells 12, 28. The case 30 also includes coolant passages (not shown) to form a heat exchanger 32 in contact with the battery cells 12, 28 for exchanging heat with the battery cells 12, 28. A thermal management apparatus 34, such as a fan, pump or compressor, provides a flow of coolant to the heat exchanger 32 through a conduit 36, for transferring heat from heat exchanger 32 to a heat sink (not shown), such as ambient air, radiator coolant of a vehicle, or fuel in an aircraft.

The four internal cells 12 have an internal cavity 14 filled with PCM 16, of the type described above in relation to the embodiment shown in FIG. 1. The four corner cells 28 receive more cooling from the heat exchanger 32 than the internal cells 12, by virtue of the corner cells 28 being in contact with the heat exchanger 32 along the end and the side of the case 30. In other embodiments it may be desirable to have other arrangements with a greater or lesser number of cells 12 including the PCM 16. The spaces 38 between the cells 12, 28 and the spaces 40 between the cells 12, 28 and the case 30 are also filled with PCM.

We contemplate that our invention may find particular utility with batteries of the type used in electric or hybrid vehicles, that utilize Lithium (Li) battery cells, Lithium ion battery cells, or Nickel metal hydride battery cells. These cells often generate significant amounts of heat during operation, and require a complex cooling system for operational safety, efficiency and to achieve long battery life. For such an application, we contemplate that the maximum temperature of the battery cell should not exceed 50 C. Temperature gradients within the cell should also not be allowed to exceed 20 C, in order to preclude inducing detrimental thermal stresses within the cell.

We further contemplate that a paraffin wax having the properties listed in Table 1 below would be suitable for use in an embodiment of our invention used in a battery of a hybrid vehicle. Such materials are sold under the trade name RUBITHERM® RT 35 by RUBITHERM Gmbh, of Hamburg, Germany.

TABLE 1
PHYSICAL PROPERTIES OF A PARAFFIN WAX PCM

| PROPERTY | VALUE |
|---|---|
| Density of melted wax, at 70 C. | 0.76 |
| Density of solid wax, at 15 C. | 0.88 |
| Melting temperature (C.) | 35 |
| Congealing temperature (C.) | 36 |
| Cp (melted wax) | 2.4 |
| Cp (solid wax) | 1.8 |
| Heat storage capacity | 157 |
| (Temperature range 27 C. to 42 C.) | |

Our invention also provides a method for operating a battery 10 having a battery cell 12 by placing a phase change material 16 inside the battery cell 12, and exchanging heat generated by the battery cell 12 to and from the phase change material 16 inside the battery cell 12. Heat stored in the phase change material 16 is transferred through the battery cell 12 to a heat exchange apparatus 30, 34 external to the battery cell 12.

### Examples

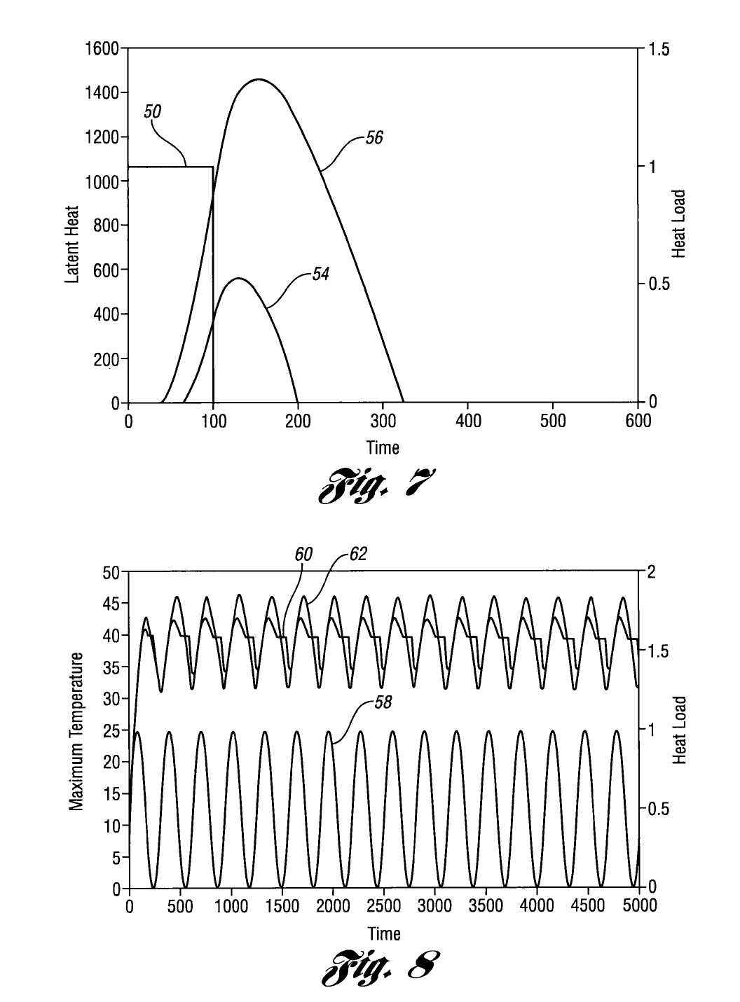

Thermal management in a cylindrical shaped battery cell 12, as shown in FIG. 1, was simulated using a finite difference computer model. Heat transfer through the cell in the longitudinal direction was not addressed in the simulation, thereby reducing the simulation to a one-dimensional radial analysis. The battery cell 12 was cooled uniformly about its outer cylindrical periphery. The simulation was performed for both a pulse load and a periodic load, with and without the PCM 16 inside of the battery cell 12. The results of the analysis are presented in FIGS. 5-8, in arbitrary units [AU], for two different PCM formulations generally having the properties shown in TABLE 1, and melting temperatures of 30 [AU] and 35 [AU].

FIG. 5 shows the maximum temperature of the simulated battery cell for three different cases, starting from an initial temperature of 20 [AU], as a result of a power pulse 50 being drawn from the cell. Curve 52 shows the simulated results for a cell without PCM inside. Curve 54 shows the simulated results for a cell with a PCM having a melting temperature of 35 [AU], and curve 56 shows the simulated results for a cell with a PCM having a melting temperature of 30 [AU].

FIGS. 6 and 7 show the temperature differential and latent heat stored in the phase change for the same three different cases shown in FIG. 5, starting from an initial temperature of 20 [AU], as a result of a power pulse 50 being drawn from the cell. The curves labeled 52 show the simulated results for a cell without PCM inside. The curves labeled 54 show the simulated results for a cell with a PCM having a melting temperature of 35 [AU], and the curves labeled 56 show the simulated results for a cell with a PCM having a melting temperature of 30 [AU].

As will be seen by comparing curves 52-56 of FIGS. 5-7, the highest maximum temperature and greatest temperature differential is reached in the cell without PCM disposed in an internal cavity of the cell. The PCM material lowers the maximum temperature and temperature differential in the battery cell by absorbing energy within the latent heat of changing phase, and slows the rate at which the battery cell cools after the end of the pulse 50, thereby promoting efficiency of operation and reducing transient thermal stresses within the cell.

FIG. 8 shows the maximum temperature of the simulated battery cell, starting from an initial temperature of 20 [AU], as a result of power draw being drawn from the cell in a periodic manner, as shown in the curve labeled 58. Curve 60 shows the simulated results for a cell without PCM inside. Curve 62 shows the simulated results for a cell with a PCM inside, according to our invention.

While the embodiments of our invention disclosed herein are presently considered to be preferred, various changes and modifications can be made without departing from the spirit and scope of the invention. For example, our invention can also be practiced with a refrigerant, or another type of PCM that makes a phase transition between liquid and gaseous states, or with a PCM that makes a solid to solid phase change.

The scope of the invention is indicated in the appended claims, and all changes or modifications within the meaning and range of equivalents are intended to be embraced therein.

We claim:

1. A battery comprising a battery cell having an internal cavity and a phase change material disposed in the internal cavity of the battery cell.

2. The battery of claim 1 wherein the cell is tubular shaped.

3. The battery of claim 1 wherein the battery cell is cylindrical in shape and defines a longitudinal axis thereof and the internal cavity extends along the longitudinal axis.

4. The battery of claim 1 wherein the battery cell and internal cavity are rectilinear shaped.

5. The battery of claim 1 wherein the battery cell is prismatic in shape.

6. The battery of claim 1 wherein the battery cell having the internal cavity is a first battery cell and the battery cell defines a wall of the internal cavity, and the battery further comprises:
a second battery cell disposed within the internal cavity of the first battery cell and spaced from the wall to form a gap between the first and second battery cells; and
the phase change material is disposed in the gap between the first and second battery cells.

7. The battery of claim 1 wherein the battery cell includes an outer surface thereof, and the battery further comprises a battery case contacting at least a portion of the outer surface of the battery cell.

8. The battery of claim 7 further comprising a heat exchanger operatively connected to the battery case.

9. The battery of claim 8 wherein the heat exchanger is integrally joined with the battery case.

10. The battery of claim 1 further comprising two or more battery cells at least one of which has an internal cavity with a phase change material disposed therein.

11. The battery of claim 10 wherein the two battery cells define a space therebetween having phase change material therein.

12. The battery of claim 11 further comprising a battery case disposed about the battery cells and the space therebetween and contacting at least one of the battery cells.

13. The battery of claim 12 wherein the battery case defines a void about at least part of one of the battery cells and a phase change material is disposed in the void.

14. A battery apparatus, comprising:
a battery cell having an internal cavity;
a phase change material disposed in the internal cavity of the battery cell; and
a heat exchanger in contact with the battery cell for exchanging heat with the battery cell.

15. The battery apparatus of claim 14, further comprising a thermal management apparatus for exchanging heat with the heat exchanger.

16. The battery of claim 15 further comprising two or more battery cells at least one of which has an internal cavity with a phase change material disposed therein.

17. The battery of claim 16 wherein the two battery cells define a space therebetween having phase change material therein.

18. A method for operating a battery having a battery cell, the method comprising placing a phase change material inside the battery cell.

19. The method of claim 19 further comprising exchanging heat generated by the battery cell in operation to and from the phase change material inside the battery cell.

20. The method of claim 20 further comprising transferring heat stored in the phase change material through the battery cell to a heat exchange apparatus external to the battery cell.
